(19) United States
(12) Patent Application Publication
(10) Pub. No.: US 2019/0314238 A1
(43) Pub. Date: Oct. 17, 2019

(54) EXTENSION ASSISTING DEVICE

(71) Applicant: INNOPHYS CO., LTD., Tokyo (JP)

(72) Inventor: Hiroshi Kobayashi, Tokyo (JP)

(73) Assignee: INNOPHYS CO., LTD., Tokyo (JP)

(21) Appl. No.: 16/472,237

(22) PCT Filed: Dec. 21, 2017
(86) PCT No.: PCT/JP2017/046032

§ 371 Date: Jun. 21, 2019

(30) Foreign Application Priority Data
Dec. 21, 2016 (JP) 2016-247877

(51) Int. Cl. A61H 3/00; A61H 1/02

(52) U.S. Cl. CPC A61H 3/00; A61H 2201/1642; A61H 2003/007; A61H 1/0244

(57) ABSTRACT

An extension assisting device that can assist mobility of a joint is provided. An extension assisting device has: a thigh arm that engages with a front portion of a thigh of a user; and an artificial muscle that, by being operated, applies force toward a rear side from the thigh arm to the thigh of the user, and displaces the thigh of the user toward the rear side relative to an upper body.

### CROSS REFERENCE TO RELATED APPLICATIONS

This application is a U.S. National Phase Application of International Patent Application number PCT/JP2017/046032 filed on 21 Dec. 2017, which claims the priority of a Japanese Patent Application No. 2016-247877 filed on 21 Dec. 2016, the disclosures of both of which are incorporated herein by reference in their entireties.

### TECHNICAL FIELD

The present invention relates to an extension assisting device.

### BACKGROUND ART

A lower limb exercising apparatus that is used in order to support, restore or improve functions of a limb is disclosed in Japanese Patent Application Laid-Open (JP-A) No. 2007-7143. This lower limb exercising apparatus includes a supporting arm that is tiltably fixed to a rotation shaft, and a foot pad that is supported at the distal end of this supporting arm. Further, due to the foot of the user pushing the foot pad and the supporting arm being tilted, training of the lower limb of the user can be carried out.

### SUMMARY OF INVENTION

### Technical Problem

When carrying out training in order to realize normal walking, it is important to enlarge the movable range of a joint.

In view of the above-described circumstances, an object of the present invention is to provide an extension assisting device that can assist the mobility of a joint.

### Solution to Problem

An extension assisting device comprises a thigh engaging portion that that is configured to engage with a front portion of a thigh of a user; and an extension force imparting portion that, by being operated, applies force toward a rear side from the thigh engaging portion to the thigh of the user, and displaces the thigh of the user toward the rear side relative to an upper body.

In accordance with the extension assisting device, when the extension force imparting portion is operated in the state in which the user is wearing the extension assisting device, force toward the rear side is applied from the thigh engaging portion to the thigh of the user. Due thereto, the thigh of the user is displaced toward the rear side relative to the upper body. Namely, the thigh of the user is tilted around the hip joint, and the iliopsoas muscle is extended. In this way, in the extension assisting device, the movable range of the hip joint can be enlarged.

An extension assisting device comprises an upper body engaging portion that is configured to engage with a front portion of the upper body of the user, wherein, due to the extension force imparting portion being operated, force toward the rear side is applied from the upper body engaging portion to the upper body of the user.

In accordance with the extension assisting device, when the extension force imparting portion is operated, force toward the rear side is applied from the upper body engaging portion to the upper body of the user. Due thereto, the upper body of the user is displaced toward the rear side relative to the thigh. As a result, the iliopsoas muscle is extended even more, and the movable range of the hip joint can be enlarged even more.

In an extension assisting device, the thigh engaging portion is structured to include a thigh pad that is disposed along a front surface of the thigh of the user, and an adjusting pad, which adjusts an interval between the thigh pad and the thigh of the user, is mounted to a user thigh side of the thigh pad.

In accordance with the extension assisting device, by adjusting the thickness of the adjusting pad, the movable angle of the hip joint at the time of operation of the extension force imparting portion (the relative angle of the thigh of the user with respect to the upper body) can be adjusted.

In an extension assisting device, in a state in which the user is in an upright posture and is standing still, the extension force imparting portion displaces the thigh of the user toward the rear side relative to the upper body.

In accordance with the extension assisting device, in a state in which the user is in an upright state and is standing still, the extension force imparting portion displaces the thigh of the user toward the rear side relative to the upper body. In this way, in accordance with the extension assisting device, training that enlarges the movable range of the hip joint can be carried out even in a case in which a large space cannot be taken-up at the periphery of the user.

### Advantageous Effects of Invention

The extension assisting device relating to the present invention has the excellent effect of being able to assist the mobility of a joint.

### BRIEF DESCRIPTION OF DRAWINGS

FIG. 1A is a perspective view in which an extension assisting device of a first embodiment is seen from an obliquely front side.

FIG. 1B is a side view in which the extension assisting device of the first embodiment is seen from a lateral side.

FIG. 2A is a side view showing a first pulley.

FIG. 2B is a schematic drawing that shows an air supply control device.

FIG. 3A is a side view showing an artificial muscle.

FIG. 3B is a schematic drawing that shows an elastic tube and a mesh sleeve that structure the artificial muscle shown in FIG. 3A.

FIG. 4 is a side view showing a state in which a user is wearing the extension assisting device and a state in which an actuator is operated.

FIG. 5 is a side view corresponding to FIG. 4 and showing a state in which the user is wearing the extension assisting device and a state in which the actuator is operated.

FIGS. 6A through 6C are perspective views showing adjusting pads of respectively different thicknesses.

FIG. 7 is a side view showing a state in which the user is wearing the extension assisting device to which an adjusting pad is not mounted, and a state before the actuator is operated.

FIG. 8 is a side view corresponding to FIG. 7 and showing a state in which the user is wearing the extension assisting device to which the adjusting pad is mounted, and a state before the actuator is operated.

FIG. 9 is a perspective view in which an extension assisting device of a second embodiment is seen from an obliquely front side.

FIG. 10A is a side view schematically showing the user before using the extension assisting device of the first embodiment.

FIG. 10B is a side view schematically showing the user after using the extension assisting device of the first embodiment.

FIG. 11A is a side view schematically showing the user before using the extension assisting device of the first embodiment.

FIG. 11B is a side view schematically showing the user after using the extension assisting device of the first embodiment.

FIG. 12A is a side view showing a state in which the user, before using the extension assisting device of the first embodiment, is sitting with legs bent beneath.

FIG. 12B is a side view showing a state in which the user, after using the extension assisting device of the first embodiment, is sitting with legs bent beneath.

### DESCRIPTION OF EMBODIMENTS

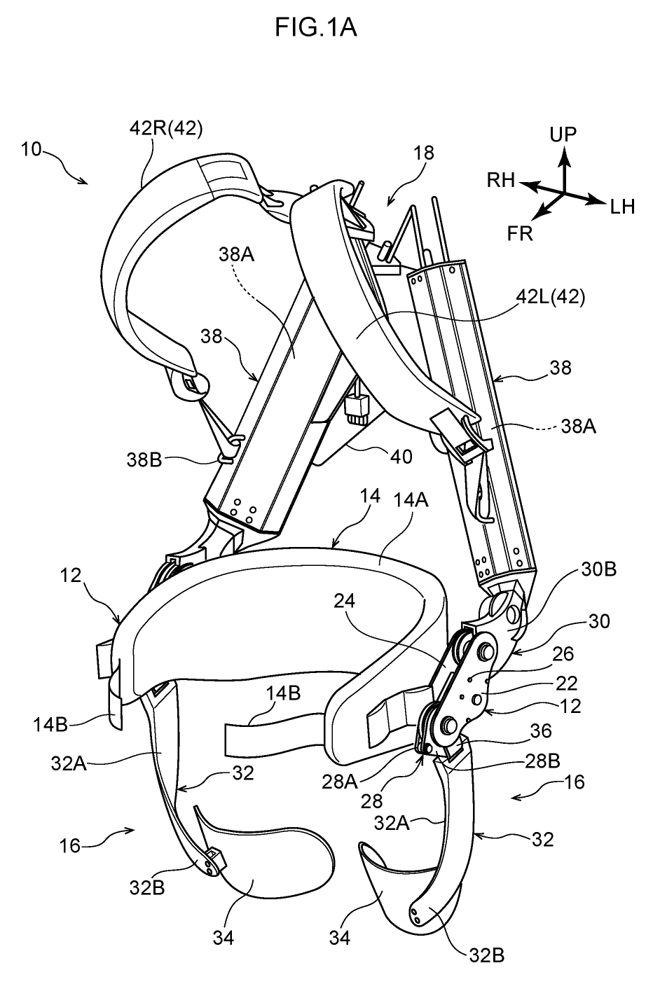

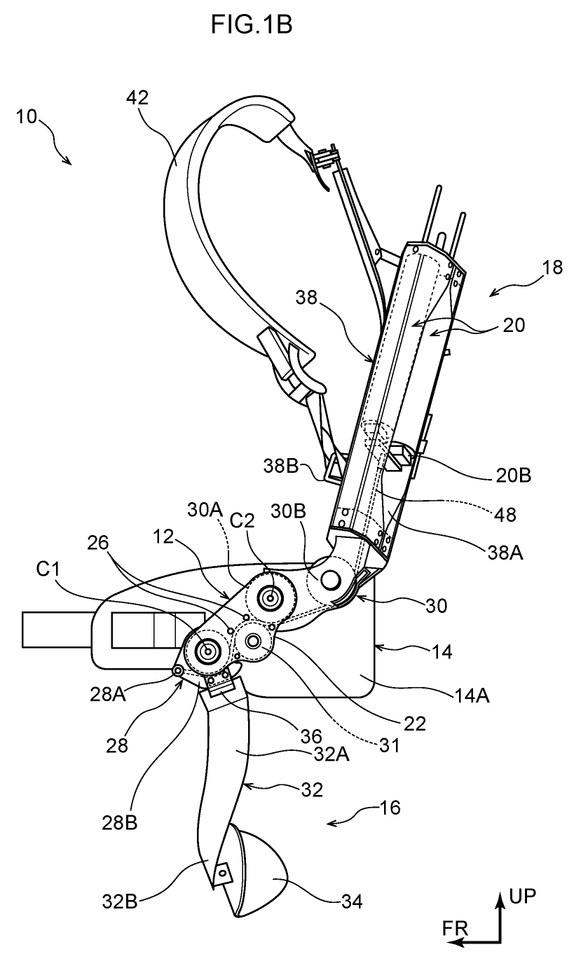

An extension assisting device relating to a first embodiment of the present invention is described by using FIG. 1A through FIG. 3. Note that the front-rear direction front side, as seen from a user who is in a state of wearing the extension assisting device and is in an upright state, is denoted by arrow FR, the right side and the left side are denoted by arrow RH and arrow LH respectively, and the up-down direction upper side is denoted by arrow UP. Further, in the following description, when merely front-rear, left-right and up-down directions are used, they refer to the front and the rear, the left and the right, and up and down as seen from the user who is in a state of wearing the extension assisting device and is in a standing state.

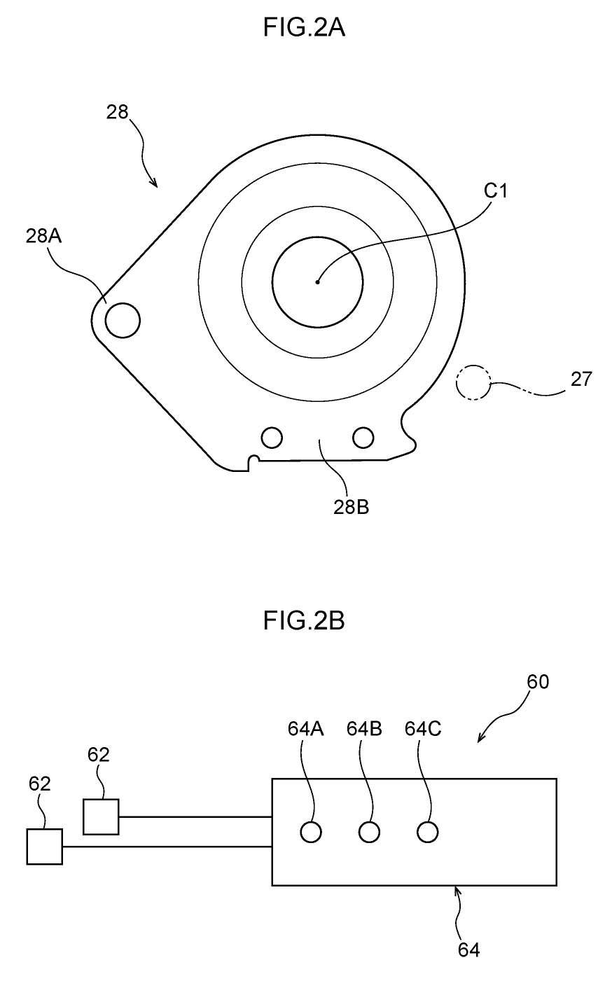

As shown in FIG. 1A and FIG. 1B, an extension assisting device 10 has a pair of left and right base portions 12 that are disposed at lateral sides of a lumbar region of the user, and a lumbar belt 14 that is mounted to the base portions 12 and is worn on the lumbar region of the user. Further, the extension assisting device 10 has thigh arms 16 that serve as thigh engaging portions, that are disposed along thighs of the user, and that are tiltably mounted to the base portions 12. The extension assisting device 10 further has an upper body side frame 18 that structures a portion of an upper body engaging portion, that is disposed along an upper body of the user, and that is tiltably mounted to the base portions 12. Moreover, the extension assisting device 10 has artificial muscles 20 that serve as extension force imparting portions and that are disposed within the upper body side frame 18, and an air supply control device 60 (see FIG. 2B) that controls the supply of air to the artificial muscles 20, and the like.

The base portion 12 is structured to include an outer side plate 22 and an inner side plate 24 that are formed in the shapes of plates. The outer side plate 22 and the inner side plate 24 are formed in substantially the same shapes as seen in a side view (as seen from the right side or the left side). Further, the outer side plate 22 and the inner side plate 24 are connected via plural connecting pins 26 or the like. Due thereto, the outer side plate 22 and the inner side plate 24 are disposed parallel to one another and with a predetermined interval therebetween in the left-right direction.

A first pulley 28, a second pulley 30 and a guide pulley 31 are rotatably provided between the outer side plate 22 and the inner side plate 24. As shown in FIG. 1A, FIG. 1B and FIG. 2A, the first pulley 28 is mounted to the lower portion sides of the outer side plate 22 and the inner side plate 24, with the left-right direction being the rotational axis direction thereof. The rotational axis of this first pulley 28 is first axis C1 that corresponds to the hip joint of the user. Further, the first pulley 28 has a wire anchor portion 28A on which a portion of a wire 48 that is described later is anchored, and a thigh arm mounting portion 28B to which the thigh arm 16 that is described later is mounted. Here, due to the first pulley 28 being rotated toward one side (being rotated in the counterclockwise direction as seen in a left side view) and the first pulley 28 abutting abutted portions 27 (see FIG. 2A) that are fixed to the outer side plate 22 and the inner side plate 24 or the like, rotation of the first pulley 28 toward the one side is restricted. As a result, tilting, toward the rear side, of the thigh arm 16 that is mounted to the thigh arm mounting portion 28B of the first pulley 28 is restricted.

The second pulley 30 is mounted to the upper portion sides of the outer side plate 22 and the inner side plate 24 and at the rear side of the first pulley 28, with the left-right direction being the rotational axial direction thereof. The rotational axis of the second pulley 30 is second axis C2 that corresponds to the sacroiliac joint of the user. Further, a guide groove 30A, which is for guiding the length direction intermediate portion of the wire 48 that is described later, is formed in the outer peripheral portion of the second pulley 30. Moreover, the second pulley 30 has an upper body side frame mounting portion 30B that extends-out toward the rear side and to which the upper body side frame 18 that is described later is mounted.

Note that the guide pulley 31 is provided between the first pulley 28 and the second pulley 30, and guides the length direction intermediate portion of the wire 48 that is described later.

The lumbar belt 14 has a wide pad 14A that, by being formed in a substantial C-shape whose front side is open as seen from the upper side of the user, is disposed along the rear side and the lateral sides of the lumbar region of the user. Further, the lumbar belt 14 has front extending portions 14B that respectively extend-out from the left-right direction both end portions of the wide pad 14A. The lumbar belt 14 is worn on the lumbar region of the user due to one of the front extending portions 14B being anchored on the other of the front extending portions 14B in a state in which the circumference of the annular portion that is formed by the wide pad 14A and the pair of front extending portions 14B is adjusted to the length around the waist of the user.

The thigh arm 16 is structured to include an arm main body 32 that extends along the thigh of the user, and a thigh pad 34 that is mounted to the arm main body 32. The arm main body 32 is formed by subjecting a plate-shaped member to a bending process or the like. This arm main body 32 has a lateral side extending portion 32A that is disposed at the lateral side of the thigh of the user, and a front side extending portion 32B that extends toward the front side of the thigh of the user from the lower end side of the lateral side extending portion 32A. As shown in FIG. 1B, the lateral side extending portion 32A is inclined toward the front side while heading toward the lower side. Due to the upper end portion of this lateral side extending portion 32A being mounted via a hinge 36 to the thigh arm mounting portion 28B of the first pulley 28, the thigh arm 16 is mounted to the base portion 12 so as to be able to tilt with the first axis C1 being the axis of tilting (rotation). Note that, in the present embodiment, the thigh arm 16 can tilt with respect to the base portion 12 in the left-right direction as well due to the hinge 36 being structured so as to be able to rotate in the left-right direction.

The thigh pad 34 is formed in a curved shape that runs along the front side surface of the thigh of the user. This thigh pad 34 is mounted to the front side extending portion 32B of the arm main body 32. Further, the thigh pad 34 can rotate with respect to the arm main body 32 by a predetermined angle with the left-right direction being the axial direction. Due thereto, the state of contact between the thigh pad 34 and the front side surface of the thigh of the user can be set to a desired state of contact.

As shown in FIG. 1A and FIG. 1B, the upper body side frame 18 is formed in a substantial U-shape (a V-shape) whose lower side is open as seen in a front view (as seen from the front side of the user). The upper body side frame 18 is structured to have a pair of artificial muscle mounting portions 38 that have artificial muscle housing portions 38A (see FIG. 1B) that are disposed with an interval therebetween in the left-right direction and at whose interiors the artificial muscles 20 are disposed, and a connecting portion 40 that connects the upper side regions of the pair of artificial muscle mounting portions 38 in the left-right direction. The pair of artificial muscle mounting portions 38 are respectively inclined toward the right side and the left side of the user while heading from the upper side toward the lower side as seen in a front view. Further, upper body attachment belt mounting portions 38B, to which are mounted upper body attachment belts 42 that are worn on the upper body of the user, are provided at the pair of artificial muscle mounting portions 38. The upper body attachment belts 42, which structure other portions of the upper body engaging portion, are structured to include a right side attachment belt 42R that is worn on the right shoulder of the user, and a left side attachment belt 42L that is worn on the left shoulder of the user. The lengths of the right side attachment belt 42R and the left side attachment belt 42L respectively are adjustable.

Further, the lower end portions of the pair of artificial muscle mounting portions 38 are fixed to the upper body side frame mounting portions 30B of the second pulleys 30. Due thereto, the upper body side frame 18 can be tilted with respect to the base portions 12 with the second axes C2 being the axes of tilting (rotation).

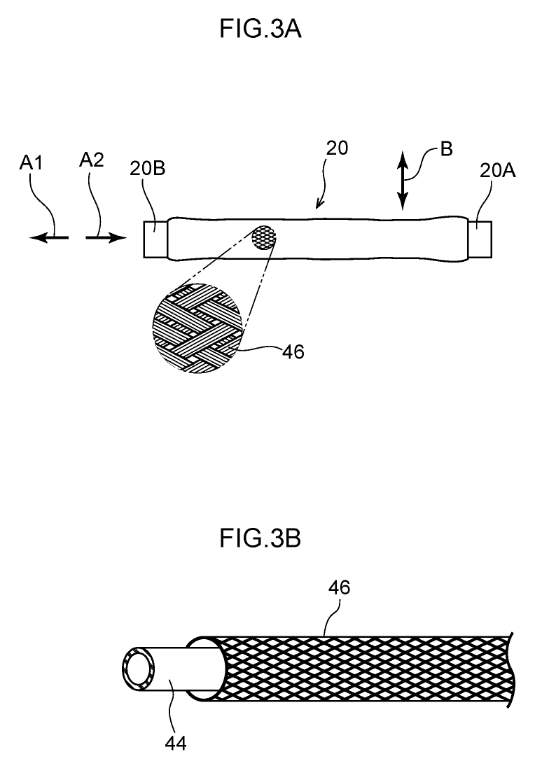

As shown in FIG. 3(A) and FIG. 3(B), the artificial muscle 20 is a so-called McKibben-type artificial muscle. A length direction one side end portion of this artificial muscle 20 is a frame anchor portion 20A that is anchored to the upper end portion of the artificial muscle mounting portion 38 (see FIG. 1B) of the upper body side frame 18. The length direction another side end portion of the artificial muscle 20 is a wire anchor portion 20B to which the wire 48 (see FIG. 1B) that is described later is anchored. To describe the detailed structure of the artificial muscle 20, as shown in FIG. 3(B), this artificial muscle 20 is structured to include an elastic tube 44 that is formed in the shape of a pipe by using an elastic material such as rubber or the like, and a mesh sleeve 46 that is formed in the shape of a tube and serves as a cover member that covers the elastic tube 44.

The elastic tube 44 has, at the interior thereof, a space into which gas (air) is supplied, and the elastic tube 44 is disposed between the frame anchor portion 20A and the wire anchor portion 20B. Air is supplied into the interior of the elastic tube 44 via an electromagnetic valve 62 (see FIG. 2B) that is described later.

The mesh sleeve 46 is formed by, for example, wires, such as high-tension fibers or the like that have low stretchability, being woven up, or the like. As shown in FIG. 3(A), the length (axial) direction both end portions of the mesh sleeve 46 are fixed to the frame anchor portion 20A and the wire anchor portion 20B, respectively.

Further, when air is supplied to the interior of the elastic tube 44 (see FIG. 3(B)) that is disposed within the mesh sleeve 46, and the elastic tube 44 inflates, the dimension in the direction (the arrow B direction) orthogonal to the length direction of the mesh sleeve 46 increases, and the dimension in the length direction (the arrow A1 and arrow A2 directions) of the mesh sleeve 46 decreases. Due thereto, the length of the artificial muscle 20 shortens (the artificial muscle 20 contracts), and the wire 48 (see FIG. 1B) that is anchored on the wire anchor portion 20B of the artificial muscle 20 is pulled.

As shown in FIG. 1A and FIG. 1B, in the present embodiment, two of the artificial muscles 20 that are described above are provided in each of the interior of the artificial muscle housing portion 38A of the artificial muscle mounting portion 38 that is at the right side and the interior of the artificial muscle housing portion 38A of the artificial muscle mounting portion 38 that is at the left side, respectively. Further, air is supplied independently at the left and the right respectively to the elastic tubes 44 of the artificial muscles 20 that are disposed at the interiors of the artificial muscle housing portions 38A of the respective artificial muscle mounting portions 38.

As shown in FIG. 1B, the wire 48, which is anchored to the wire anchor portions 20B of the artificial muscles 20 that are disposed at the interior of the artificial muscle housing portion 38A of the artificial muscle mounting portion 38 that is at the left side, is led-out from the lower end side of the artificial muscle mounting portion 38 at the left side, and moreover, the another end portion of this wire 48 is anchored on the wire anchor portion 28A of the first pulley 28 to which the thigh arm 16 at the left side is mounted. Note that, although not illustrated, the wire 48, which is anchored to the wire anchor portions 20B of the artificial muscles 20 that are disposed at the interior of the artificial muscle housing portion 38A of the artificial muscle mounting portion 38 that is at the right side, is led-out from the lower end side of the artificial muscle mounting portion 38 at the right side, and moreover, the another end portion of this wire 48 is anchored on the wire anchor portion 28A of the first pulley 28 to which the thigh arm 16 at the right side is mounted.

As shown in FIG. 2B, the air supply control device 60 has a pair of the electromagnetic valves 62 for supplying air to the artificial muscles 20 that are provided at the interior of the artificial muscle housing portion 38A of the artificial muscle mounting portion 38 at the right side and to the artificial muscles 20 that are provided at the interior of the artificial muscle housing portion 38A of the artificial muscle mounting portion 38 at the left side, or for exhausting the supplied air. Further, the air supply control device 60 has an operation portion 64 having a first switch 64A, a second switch 64B and a third switch 64C that operate the pair of electromagnetic valves 62 respectively. Further, in the present embodiment, due to the first switch 64A being pushed, one of the electromagnetic valves 62 is operated, and air is supplied into the artificial muscles 20 that are provided at the interior of the artificial muscle housing portion 38A of the artificial muscle mounting portion 38 that is at the left side. Note that, when the first switch 64A is released, the air, which has been supplied into the artificial muscles 20 that are provided at the interior of the artificial muscle housing portion 38A of the artificial muscle mounting portion 38 at the left side, is exhausted. Further, due to the second switch 64B being pushed, the other of the electromagnetic valves 62 is operated, and air is supplied into the artificial muscles 20 that are provided at the interior of the artificial muscle housing portion 38A of the artificial muscle mounting portion 38 that is at the right side. Note that, when the second switch 64B is released, the air, which has been supplied into the artificial muscles 20 that are provided at the interior of the artificial muscle housing portion 38A of the artificial muscle mounting portion 38 at the right side, is exhausted. Moreover, due to the third switch 64C being pushed, both of the electromagnetic valves 62 are operated, and air is supplied into the artificial muscles 20 that are provided at the interiors of the artificial muscle housing portions 38A of the left and right artificial muscle mounting portions 38 (all of the artificial muscles 20). Note that, when the third switch 64C is released, the air, which has been supplied into the artificial muscles 20 that are provided at the interiors of the artificial muscle housing portions 38A of the left and right artificial muscle mounting portions 38, is exhausted.

(Operation and Effects of Present Embodiment)

Operation and effects of the present embodiment are described next.

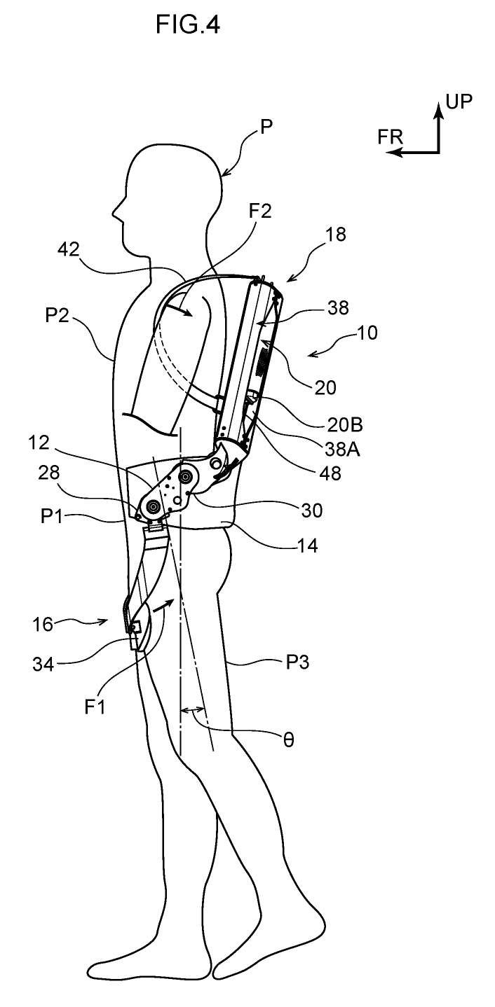

As shown in FIG. 4, in the present embodiment, the extension assisting device 10 is put on a user P due to the lumbar belt 14, the upper body attachment belts 42, and the thigh arms 16 being respectively attached to (anchored to) a lumbar region P1, an upper body P2 and thighs P3 of the user P.

Further, in the state in which the user P is in a standing posture and is standing still, when the first switch 64A (see FIG. 2B) of the operation portion 64 is pushed and air is supplied from an unillustrated gas supplying portion (a compressor or a tank) via one of the electromagnetic valves 62 (see FIG. 2B) to the elastic tubes 44 of the artificial muscles 20 that are disposed at the interior of the artificial muscle housing portion 38A of the artificial muscle mounting portion 38 that is at the left side, the artificial muscles 20 contract. Due thereto, the wire 48 that is anchored on the wire anchor portions 20B of the artificial muscles 20 is pulled, and the first pulley 28 to which the wire 48 is connected is rotated toward one side (is rotated in the counterclockwise direction as seen in a left side view). As a result, the thigh arm 16 at the left side that is mounted to the thigh arm mounting portion 28B of the first pulley 28 is tilted toward the rear side, and the thigh pad 34 of this thigh arm 16 pushes, toward the rear side, the thigh P3 that is at the left side of the user P (force F1 toward the rear side is applied to the thigh P3 that is at the left side of the user P). Due thereto, the thigh P3 of the user P is displaced toward the rear side relative to the upper body P2. Namely, the thigh P3 of the user P is tilted by approximately angle θ (θ=7° in the present embodiment) around the hip joint. As a result, due to the iliopsoas muscle being extended and the alignment of the lumbar vertebrae and the hip joint with respect to the pelvis being adjusted and set in order, the movable range of the hip joint can be enlarged. In particular, in the present embodiment, the thigh P3 of the user P is displaced relatively toward the rear side with respect to the upper body P2 (the iliopsoas muscle is hyperextended), to a position that the user does not move to in daily life. Note that, also in a case in which the second switch 64B (see FIG. 2B) of the operation portion 64 is pushed and air is supplied to the elastic tubes 44 of the artificial muscles 20 that are disposed at the interior of the artificial muscle housing portion 38A of the artificial muscle mounting portion 38 at the right side, similarly, the thigh P3 that is at the left side of the user P is tilted by approximately the angle θ (θ=7° in the present embodiment) around the hip joint. As a result, the iliopsoas muscle can be extended, and the movable range of the hip joint can be enlarged. Here, in the present embodiment, due to the left and right artificial muscles 20 being able to be operated independently, the present extension assisting device 10 can be used even in cases in which there is a surgical problem in either one of the left or right hip joint or knee joint. Further, in the present extension assisting device 10, even in a case in which a large space cannot be taken-up at the periphery of the user P, training that enlarges the movable range of the hip joint can be carried out.

Further, in the present embodiment, when the artificial muscles 20 contract, the upper body P2 of the user P is pulled toward the rear side (force F2 toward the rear side is applied to the upper body P2 of the user P) via the upper body side frame 18 and the upper body attachment belts 42. Due thereto, the upper body P2 of the user P is displaced toward the rear side relative to the thigh P3. As a result, the iliopsoas muscle is extended even more, and the movable range of the hip joint can be enlarged even more.

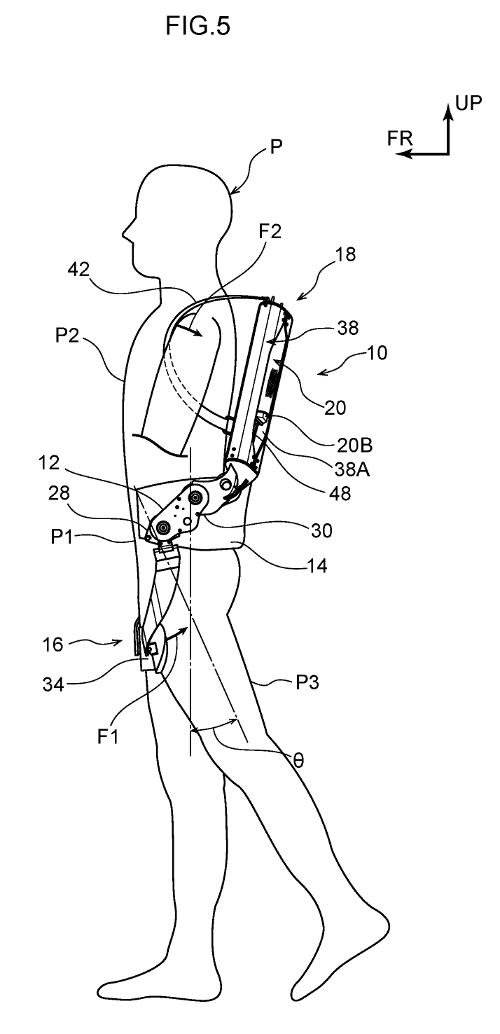

Note that it suffices for the amount of relative movement of the thigh P3 of the user P with respect to the upper body P2 (tilting angle θ of the thigh P3 of the user P) to be adjusted appropriately due to the position of abutment of the first pulley 28 with the abutted portions 27 (see FIG. 2A) being adjusted. For example, as shown in FIG. 5, the tilting angle θ (θ=14° in the example of this drawing) of the thigh P3 of the user P may be increased by increasing the angle of the rotation until the first pulley 28 abuts the unillustrated abutted portions 27 (see FIG. 2A).

(Structure Using Adjusting Pad)

In the above-described extension assisting device 10, the tilting angle θ of the thigh P3 of the user P with respect to the upper body P2 is adjusted by adjusting the abutment position of the first pulley 28 with the abutted portions 27 (see FIG. 2A). However, in a training gym or a medical setting in which the extension assisting device 10 is used, it is desirable for the users P of different physiques and ages to be able to use the extension assisting device 10 in common. Thus, by using adjusting pads 50 that are described hereinafter, training or medical activities can be carried out by using the extension assisting device 10 in common.

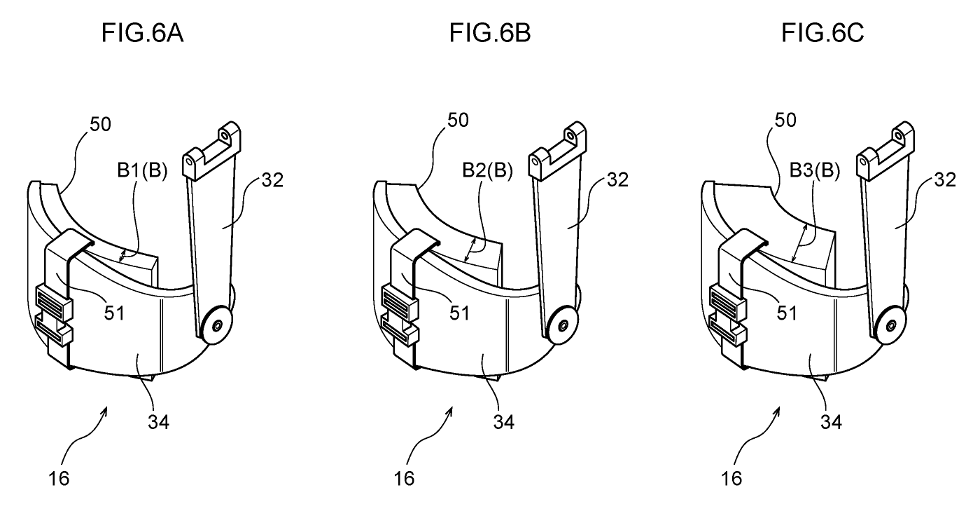

As shown in FIGS. 6(A) through (C), the adjusting pad 50 is used in order to adjust the interval between the thigh pad 34 and the thigh P3 of the user P (see FIG. 4 and the like). This adjusting pad 50 is formed in the shape of a plate by using a material (urethane or the like) that can be bendingly displaced flexibly. As an example, in the present embodiment, three types of the adjusting pads 50 that have different thickness B are used. Thickness B1 of the adjusting pad 50 shown in FIG. 6(A) is 15 mm, thickness B2 of the adjusting pad 50 shown in FIG. 6(B) is 30 mm, and thickness B3 of the adjusting pad 50 shown in FIG. 6(C) is 45 mm. Further, the adjusting pad 50 is mounted via a mounting belt 51 along the surface, which is at the thigh P3 side of the user P, at the thigh pad 34. Note that plural adjusting pads 50 having different thicknesses B may be mounted to the thigh pad 34 in a state in which these plural adjusting pads 50 are superposed.

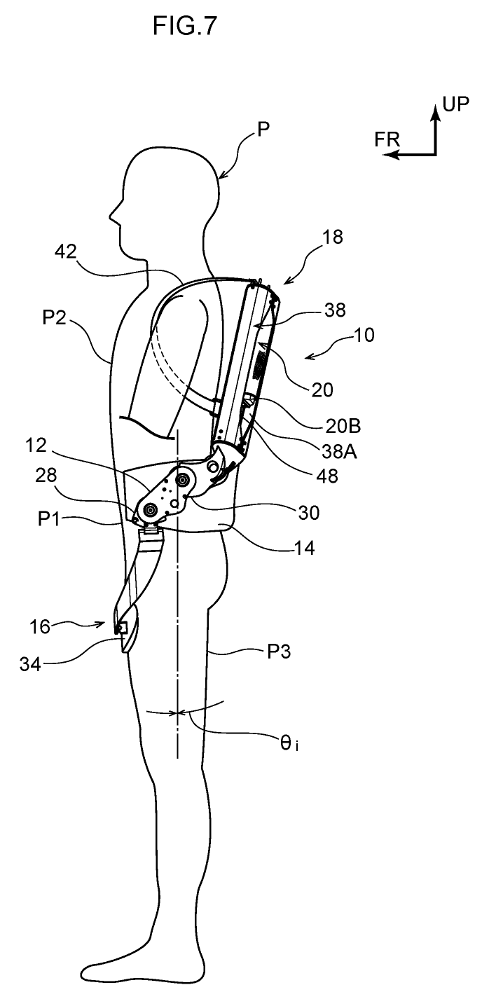

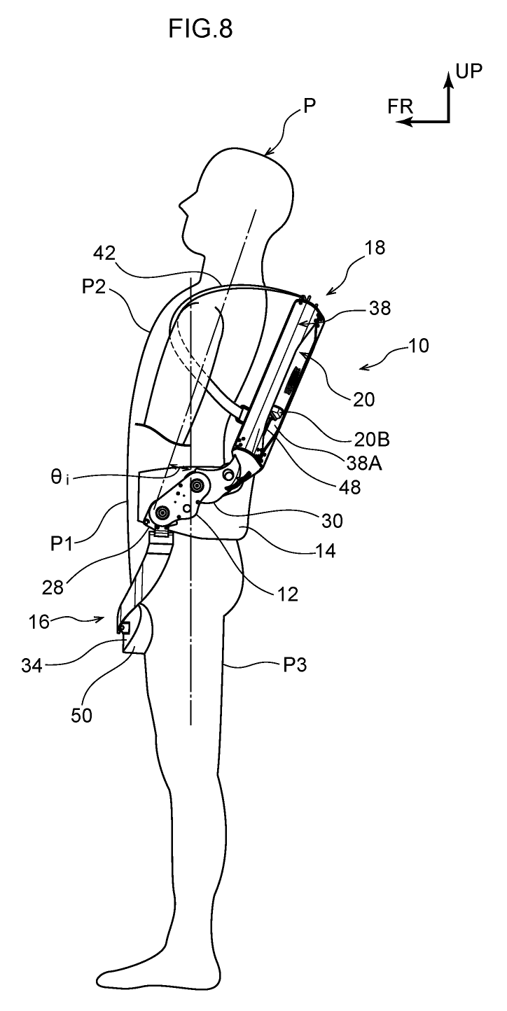

A side view of a state in which the extension assisting device 10, at which the adjusting pad 50 is not fixed to the thigh pad 34, is being worn by the user, and before the artificial muscles 20 are contracted, is shown in FIG. 7. Further, a side view of a state in which the extension assisting device 10, at which the adjusting pad 50 is fixed to the thigh pad 34, is being worn by the user, and before the artificial muscles 20 are contracted, is shown in FIG. 8. As shown in these drawings, initial angle Oi, of the thigh P3 of the user P with respect to the upper body P2 in a state before the artificial muscles 20 are contracted, can be increased by using the adjusting pad 50. As a result, by adjusting the thickness B of the adjusting pad 50 that is fixed to the thigh pad 34, the tilting angle θ (see FIG. 4 and FIG. 5) of the thigh P3 of the user P with respect to the upper body P2 at the time of contraction of the artificial muscles 20 can be adjusted. Further, in a case in which there is a surgical problem with either one of the left or right hip joint or knee joint, the thicknesses B of the left and right adjusting pads 50 may be made to differ, or the adjusting pad 50 may be used at only one of the left and the right. Moreover, the aforementioned problem may be addressed by removing the arm main body 32.

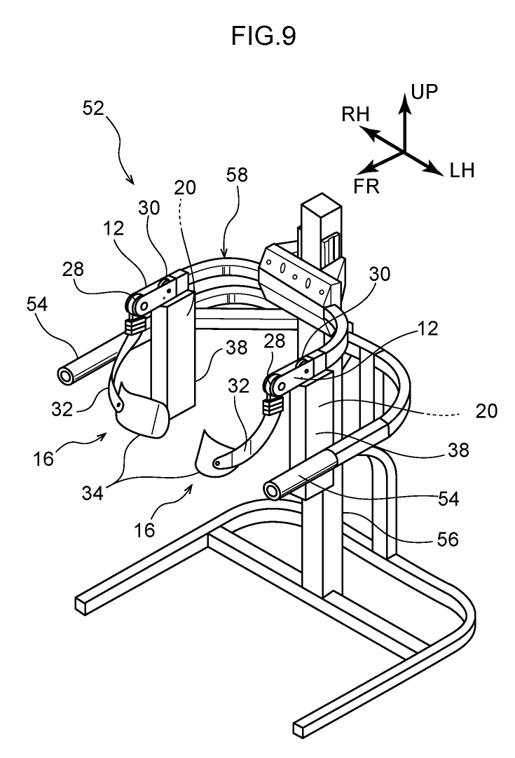

Note that, with the above-described extension assisting device 10, walking in a state in which the user is wearing the extension assisting device 10, and the like, are possible. However, the present invention may be applied to a set-type (fixed-type) extension assisting device 52 that relates to a second embodiment shown in FIG. 9. This extension assisting device 52 has a frame portion 56 that is fixed to a floor surface and that has a pair of left and right handle portions 54 that are grasped by the hands of a user. Further, a thigh pushing portion 58, which serves as an extension force imparting portion and which, by being operated, displaces the thigh of the user toward the rear side relative to the upper body, is mounted to the frame portion 56. The position of the thigh pushing portion 58 in the vertical direction with respect to the frame portion 56 can be adjusted. Note that the portions, which corresponds to the above-described extension assisting device 10, at the thigh pushing portion 58 are denoted by the same reference numerals as those of the corresponding portions of the extension assisting device 10, and description thereof is omitted.

(Results of Verifying Effects Due to Use of Extension Assisting Device 10)

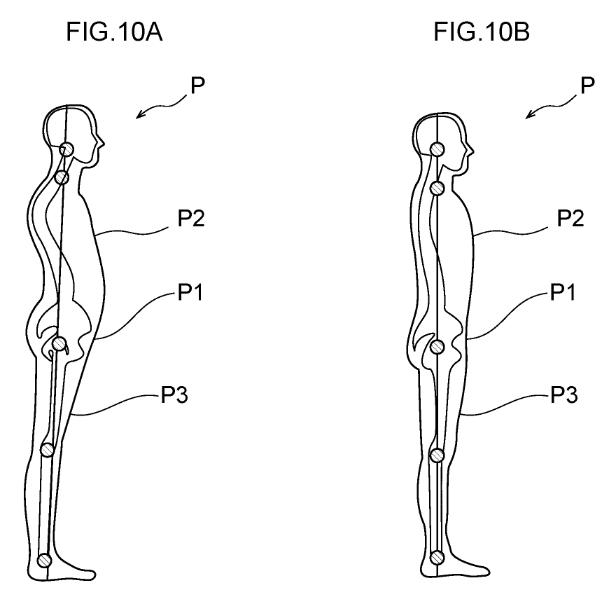

The effects provided to the user P by using the extension assisting device 10 are described next by using FIG. 10 through FIG. 12.

A schematic drawing of the user P, who is a 60-year old female and whose back is curved in a shape called a so-called high-heel form, is shown in FIG. 10(A). A schematic drawing showing the user P after using the extension assisting device 10 is shown in FIG. 10(B). As shown in these drawings, it can be understood that the curvature of the back of the user P improves after use of the extension assisting device 10.

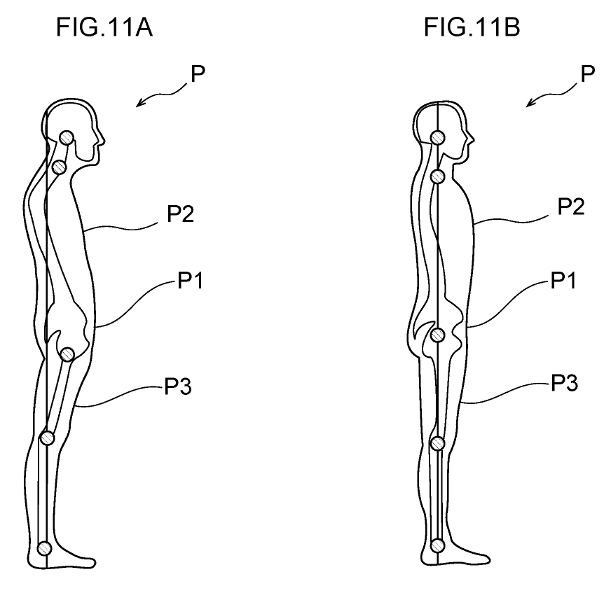

Further, a schematic drawing of the user P, who is a 55-year old male who is curved from the back to the waist in a shape called a so-called swayback form, is shown in FIG. 11(A). A schematic drawing showing the user P after using the extension assisting device 10 is shown in FIG. 11(B). As shown in these drawings, it can be understood that the curvature from the back to the waist of the user P improves after use of the extension assisting device 10.

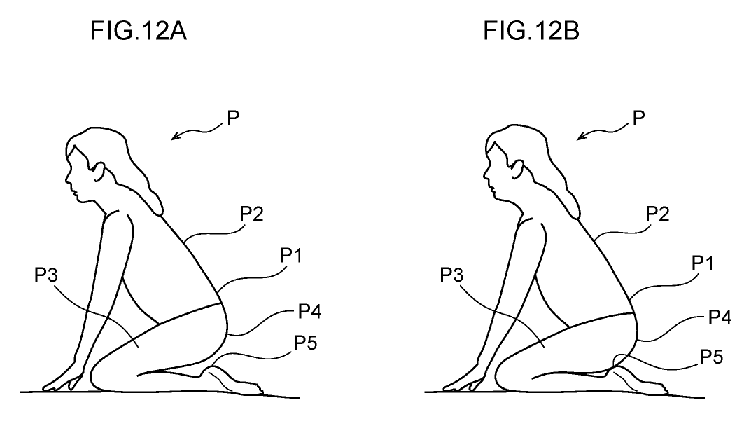

Moreover, a schematic drawing showing a state in which the user P, before using the extension assisting device 10, is seated with the knees folded-over is shown in FIG. 12(A). A schematic drawing showing a state in which the user P, after using the extension assisting device 10, is seated with the knees folded-over is shown in FIG. 12(B). As shown in these drawings, before using the extension assisting device 10, it is difficult for the user P to sit in a state in which buttocks P4 touch heels P5, whereas, after using the extension assisting device 10, it is possible for the user P to sit in a state in which the buttocks P4 touch the heels P5. Note that the user P who is shown in these drawings is the same person as the user P who is shown in FIGS. 10(A) and (B).

Although embodiments of the present invention have been described above, the present invention is not limited to the above, and, of course, can be implemented by being modified in various ways other than the above within a scope that does not depart from the gist thereof.

1. An extension assisting device comprising:
a thigh engaging portion configured to engage with a front portion of a thigh of a user; and
an extension force imparting portion that, by being operated, applies force toward a rear side from the thigh engaging portion to the thigh of the user, and displaces the thigh of the user toward the rear side relative to an upper body of the user.

2. The extension assisting device of claim 1, further comprising an upper body engaging portion that is configured to engage with a front portion of the upper body of the user,
wherein, due to the extension force imparting portion being operated, force toward the rear side is applied from the upper body engaging portion to the upper body of the user.

3. The extension assisting device of claim 1, wherein the thigh engaging portion includes:
a thigh pad disposed along a front surface of the thigh of the user, and an adjusting pad, which adjusts an interval between the thigh pad and the thigh of the user, mounted to a user thigh side of the thigh pad.

4. The extension assisting device of claim 1, wherein, in a state in which the user is in an upright posture and is standing still, the extension force imparting portion displaces the thigh of the user toward the rear side relative to the upper body.
